(19) United States
(12) Patent Application Publication
(10) Pub. No.: US 2023/0168671 A1
(43) Pub. Date: Jun. 1, 2023

(54) CONTROL METHOD, CONTROL DEVICE, AND STORAGE MEDIUM

(71) Applicant: TOYOTA JIDOSHA KABUSHIKI KAISHA, Toyota-shi (JP)

(72) Inventors: Kosuke AKATSUKA, Mishima-shi (JP); Rio SUDA, Toyota-shi (JP)

(73) Assignee: TOYOTA JIDOSHA KABUSHIKI KAISHA, Toyota-shi (JP)

(21) Appl. No.: 17/956,159

(22) Filed: Sep. 29, 2022

(30) Foreign Application Priority Data
Dec. 1, 2021 (JP) 2021-195473

(51) Int. Cl. G05D 1/00; G05D 1/02

(52) U.S. Cl. CPC G05D 1/005; G05D 1/0223; G05D 1/0231; G05D 1/0257; H04B 1/0053

(57) ABSTRACT

Provided is a control method for controlling a movable body by a remote operation performed by a remote operator. The control method includes: receiving information including an operation amount by the remote operator via communication; calculating a corrected operation amount by applying at least either one of linear interpolation and lowpass filtering to the received operation amount; and controlling the movable body based on the corrected operation amount. The control method further includes setting a period for the linear interpolation to be longer and decreasing a cut-off frequency in the lowpass filtering as a communication period for the operation amount is longer, or setting the period for the linear interpolation to be longer or decreasing the cut-off frequency in the lowpass filtering as the communication period for the operation amount is longer.

### CROSS-REFERENCE TO RELATED APPLICATION

This application claims priority to Japanese Patent Application No. 2021-195473 filed on Dec. 1, 2021, incorporated herein by reference in its entirety.

### BACKGROUND

### 1. Technical Field

This disclosure relates to a technology to control a movable body by a remote operation performed by a remote operator.

### 2. Description of Related Art

Japanese Unexamined Patent Application Publication No. 2019-020756 (JP 2019-020756 A) discloses a sensor signal processing apparatus. The sensor signal processing apparatus is connected to a sensor element configured to measure a physical quantity and output a sensor signal. The sensor signal processing apparatus samples a sensor signal, performs digital filtering on the sampled sensor signal, and generates digital data for transmission. Particularly, the sensor signal processing apparatus predicts a future value of the sensor signal and generates, in advance, digital data for transmission at a next transmission timing.

### SUMMARY

The following discusses a remote operation on a movable body (e.g., a vehicle, a robot) to be performed by a remote operator. A remote operation system includes a movable body as a target for a remote operation, and a remote operator terminal on a remote operator side. In the middle of the remote operation, the movable body and the remote operator terminal communicate with each other. The movable body receives information on an operation amount by the remote operator from the remote operator terminal and performs a movable body control based on the operation amount.

Since the communication between the movable body and the remote operator terminal has a communication period, the operation amount to be received by the movable body is discrete. That is, the operation amount to be received by the movable body changes in a stepped manner. In a case where the operation amount that changes in a stepped manner is used for the movable body control as it is, vibrations or abnormal noise might occur.

One object of this disclosure is to provide a technology that can restrain the occurrence of vibrations or abnormal noise at the time when a movable body is controlled by a remote operation performed by a remote operator.

A first aspect relates to a control method for controlling a movable body by a remote operation performed by a remote operator. The control method includes: receiving information including an operation amount by the remote operator via communication; calculating a corrected operation amount by applying at least either one of linear interpolation and lowpass filtering to the received operation amount; controlling the movable body based on the corrected operation amount; and setting a period for the linear interpolation to be longer and decreasing a cut-off frequency in the lowpass filtering as a communication period for the operation amount is longer, or setting the period for the linear interpolation to be longer or decreasing the cut-off frequency in the lowpass filtering as the communication period for the operation amount is longer.

A second aspect relates to a control device for controlling a movable body by a remote operation performed by a remote operator. The control device includes one or more processors. The one or more processors is configured to: receive information including an operation amount by the remote operator via communication; calculate a corrected operation amount by applying at least either one of linear interpolation and lowpass filtering to the received operation amount; control the movable body based on the corrected operation amount; and set a period for the linear interpolation to be longer and decrease a cut-off frequency in the lowpass filtering as a communication period for the operation amount is longer, or set the period for the linear interpolation to be longer or decrease the cut-off frequency in the lowpass filtering as the communication period for the operation amount is longer.

A third aspect relates to a storage medium storing a control program for controlling a movable body by a remote operation performed by a remote operator. The control program is executed by a computer. The control program causes the computer to: receive information including an operation amount by the remote operator via communication; calculate a corrected operation amount by applying at least either one of linear interpolation and lowpass filtering to the received operation amount; control the movable body based on the corrected operation amount; and set a period for the linear interpolation to be longer and decrease a cut-off frequency in the lowpass filtering as a communication period for the operation amount is longer, or set the period for the linear interpolation to be longer or decrease the cut-off frequency in the lowpass filtering as the communication period for the operation amount is longer.

In this disclosure, the movable body as a target for the remote operation receives an operation amount by the remote operator and calculates a corrected operation amount by applying at least either one of linear interpolation and lowpass filtering to the received operation amount. The corrected operation amount thus calculated changes more smoothly than the received operation amount. The movable body is controlled based on the corrected operation amount. This accordingly restrains vibrations or abnormal noise in a movable body control.

Further, the period for the linear interpolation is made longer and the cut-off frequency in the lowpass filtering decreases as the communication period for the operation amount is longer, or the period for the linear interpolation is made longer or the cut-off frequency in the lowpass filtering decreases as the communication period for the operation amount is longer. This further effectively restrains the occurrence of vibrations or abnormal noise in the movable body control.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view illustrating an exemplary configuration of a remote operation system according to an embodiment of this disclosure;

FIG. 2 is a conception diagram to describe a vehicle traveling control based on an operation amount by a remote operator;

FIG. 3 is a block diagram illustrating an exemplary functional configuration related to a smoothing process for the operation amount according to the embodiment of this disclosure;

FIG. 4 is a conception diagram to describe a linear interpolation process for the operation amount according to the embodiment of this disclosure;

FIG. 5A is a conception diagram to describe an effect of the smoothing process for the operation amount according to the embodiment of this disclosure;

FIG. 5B is a conception diagram to describe an effect of the smoothing process for the operation amount according to the embodiment of this disclosure;

FIG. 5C is a conception diagram to describe an effect of the smoothing process for the operation amount according to the embodiment of this disclosure;

FIG. 6 is a conception diagram to describe a problem to be caused in a case where a linear interpolation period is uniform;

FIG. 7 is a block diagram illustrating an exemplary functional configuration related to a smoothing process for the operation amount according to the embodiment of this disclosure;

FIG. 8 is a conception diagram to describe an effect to be obtained by dynamic setting of parameters related to the smoothing process;

FIG. 9 is a block diagram illustrating an exemplary functional configuration related to the smoothing process for the operation amount and a vehicle-speed restriction process according to the embodiment of this disclosure; and

FIG. 10 is a block diagram illustrating an exemplary configuration of a vehicle according to the embodiment of this disclosure.

### DETAILED DESCRIPTION OF EMBODIMENTS

With reference to drawings, the following describes an embodiment of this disclosure.

1. Outline of Remote Operation System

The following discusses a remote operation (remote driving) on a movable body. Examples of the movable body as a target for the remote operation include a vehicle, a robot, and so on. The vehicle may be a self-driving vehicle or may be a vehicle to be driven by a driver. The robot may be a logistics robot, an operation robot, or the like.

As an example, the following description deals with a case where the movable body as the target for the remote operation is a vehicle. In a case where the description is generalized, the “vehicle” in the following description shall be read for the “movable body.”

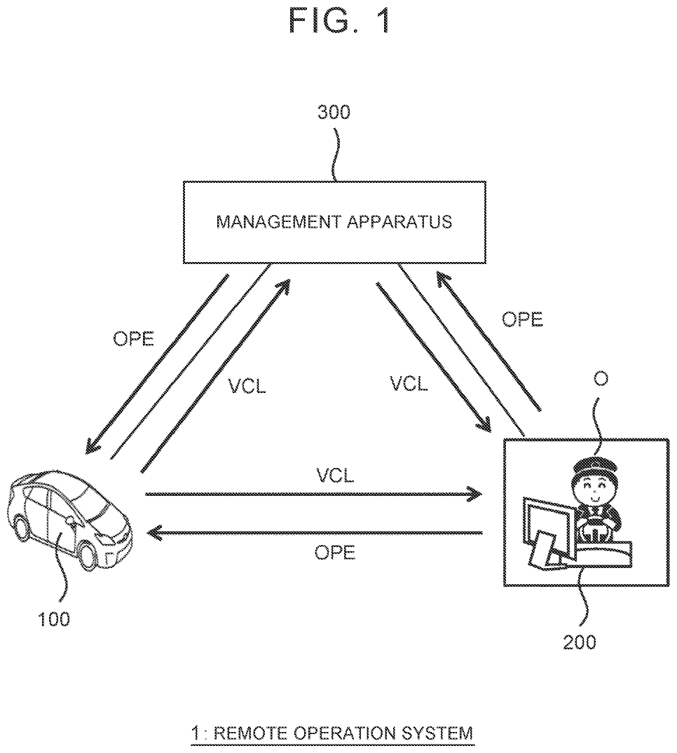

FIG. 1 is a schematic view illustrating an exemplary configuration of a remote operation system 1 according to the present embodiment. The remote operation system 1 includes a vehicle 100, a remote operator terminal 200, and a management apparatus 300. The vehicle 100 is a target for a remote operation. The remote operator terminal 200 is a terminal apparatus to be used when a remote operator O remotely operates the vehicle 100. The remote operator terminal 200 can be also referred to as a remote operation human machine interface (HMI). The management apparatus 300 manages the remote operation system 1. For example, the management apparatus 300 assigns the remote operator O to the vehicle 100. Typically, the management apparatus 300 is a management server on the cloud. The management server may be constituted by a plurality of servers configured to perform distributed processing. The vehicle 100, the remote operator terminal 200, and the management apparatus 300 are communicable with each other via a communication network.

The vehicle 100 is equipped with various sensors including a camera. The camera captures an image of a surrounding state around the vehicle 100 and acquires image information indicative of the surrounding state around the vehicle 100. Vehicle information VCL is information to be obtained by various sensors and include image information to be obtained by the camera. The vehicle 100 communicates with the remote operator terminal 200 and transmits the vehicle information VCL to the remote operator terminal 200. The vehicle 100 may transmit the vehicle information VCL to the remote operator terminal 200 via the management apparatus 300.

The remote operator terminal 200 receives the vehicle information VCL transmitted from the vehicle 100. The remote operator terminal 200 presents the vehicle information VCL to the remote operator O. More specifically, the remote operator terminal 200 includes a display device and displays image information or the like on the display device.

The remote operator O recognizes the surrounding state around the vehicle 100 based on the presented information and remotely operates the vehicle 100. Remote operation information OPE is information on a remote operation performed by the remote operator O. For example, the remote operation information OPE includes an operation amount X (a target value) by the remote operator O. Examples of the operation amount X (the target value) include a target steering angle (a target pinion angle), a target tire angle, a target yaw rate, a target lateral acceleration, a requested driving force, a requested braking force, a requested front-rear acceleration, a requested vehicle speed, and so on.

The remote operator terminal 200 communicates with the vehicle 100 and transmits the remote operation information OPE to the vehicle 100. The remote operator terminal 200 may transmit the remote operation information OPE to the vehicle 100 via the management apparatus 300.

The vehicle 100 receives the remote operation information OPE transmitted from the remote operator terminal 200. The remote operation information OPE includes an operation amount X by the remote operator O. The vehicle 100 performs a vehicle traveling control based on the operation amount X by the remote operator O. Thus, the remote operation of the vehicle 100 is implemented.

2. Smoothing of Operation Amount

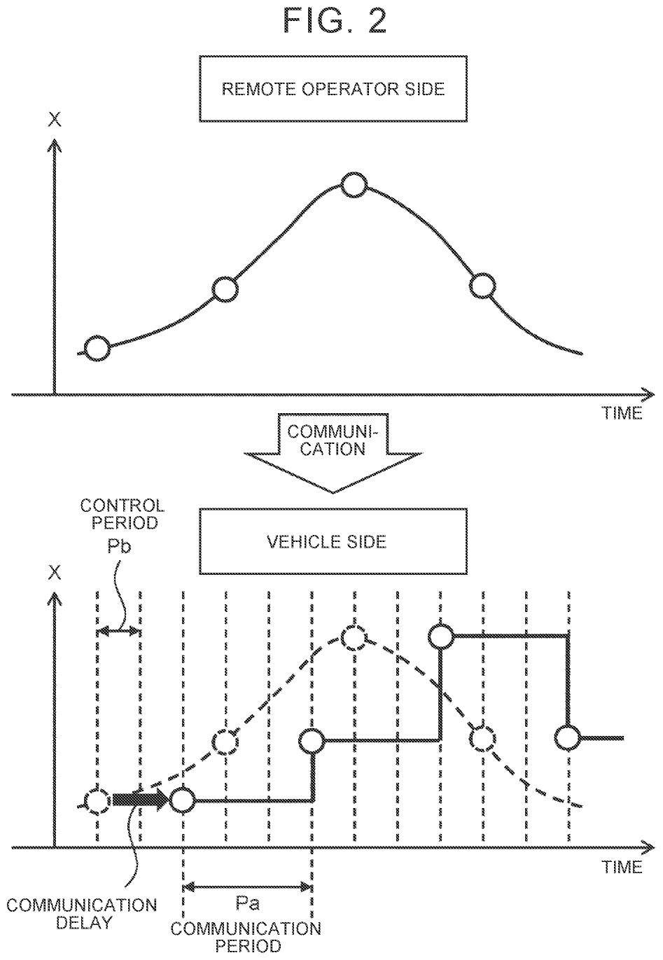

FIG. 2 is a conception diagram to describe the vehicle traveling control based on the operation amount X by the remote operator O. The horizontal axis indicates time, and the vertical axis indicates the operation amount X by the remote operator O. More particularly, the upper side in FIG. 2 indicates the change in the operation amount X on the remote operator O side over time. A circular mark on the upper side indicates an operation amount X to be transmitted to the vehicle 100 and its transmission timing. In the meantime, the lower side in FIG. 2 indicates the change in the operation amount X to be used for control in the vehicle 100 over time. A circular mark on the lower side indicates an operation amount X to be received by the vehicle 100 and its reception timing.

The communication between the vehicle 100 and the remote operator terminal 200 has a communication delay. The operation amount X on the vehicle 100 side delays only by the communication delay from the operation amount X on the remote operator O side.

Further, the communication between the vehicle 100 and the remote operator terminal 200 has a communication period. In the following description, a “communication period Pa” indicates a period during which the vehicle 100 receives the operation amount X from the remote operator terminal 200. The communication period Pa for the operation amount X can be referred to as a reception period for the operation amount X. Generally, the communication period Pa (the reception period) is longer than a control period Pb in the vehicle 100. Due the presence of the communication period Pa, the operation amount X to be received by the vehicle 100 is discrete. That is, the operation amount X to be received by the vehicle 100 changes in a stepped manner. Particularly, the communication period Pa is longer than the control period Pb, and therefore, a step-shaped change amount of the operation amount X is also large. In a case where the operation amount X that changes in a stepped manner is used in the vehicle traveling control as it is, vibrations or abnormal noise of an actuator might occur.

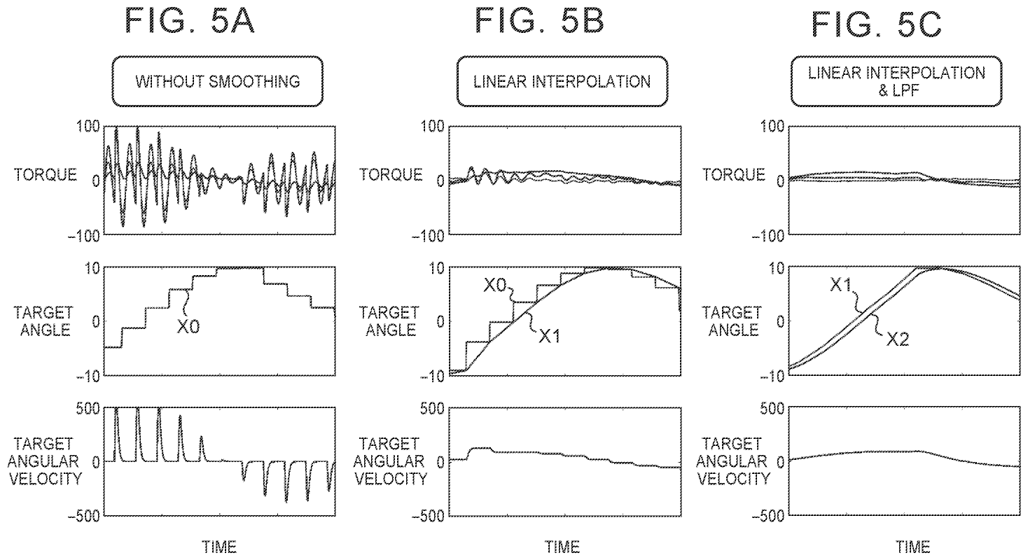

As an example, the following discusses a case where the operation amount X is a target angle for steering (see FIG. 5A). When the target angle changes in a stepped manner, a target angular velocity suddenly changes, so that the output torque from a turning motor configured to turn wheels also suddenly changes. As a result, vibrations or abnormal noise of the turning motor might occur.

In view of this, the present embodiment provides a technology that can restrain the occurrence of vibrations or abnormal noise at the time when the vehicle 100 is controlled by the remote operation performed by the remote operator O. More specifically, the vehicle 100 executes a “smoothing process” such that the operation amount X to be used in the vehicle traveling control changes smoothly.

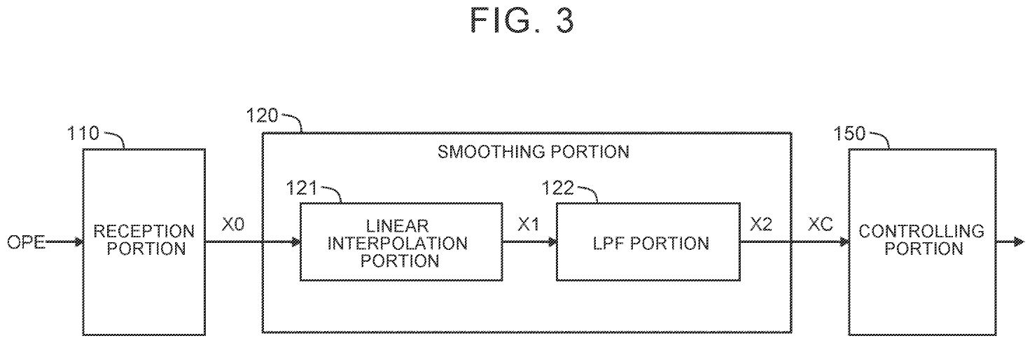

FIG. 3 is a block diagram illustrating an exemplary functional configuration related to the smoothing process according to the present embodiment. The vehicle 100 includes a reception portion 110, a smoothing portion 120, and a controlling portion 150 as functional blocks.

The reception portion 110 receives the remote operation information OPE transmitted from the remote operator terminal 200. The remote operation information OPE includes an operation amount X by the remote operator O. For convenience, the operation amount X to be received by the reception portion 110 is hereinafter referred to as a “received operation amount X0.”

The smoothing portion 120 performs a smoothing process of smoothing the received operation amount X0. An operation amount to be obtained as a result of the smoothing process performed on the received operation amount X0 is hereinafter referred to as a “corrected operation amount XC.” The corrected operation amount XC changes more smoothly than the received operation amount X0. That is, the smoothing portion 120 performs the smoothing process on the received operation amount X0 to calculate the corrected operation amount XC that changes more smoothly.

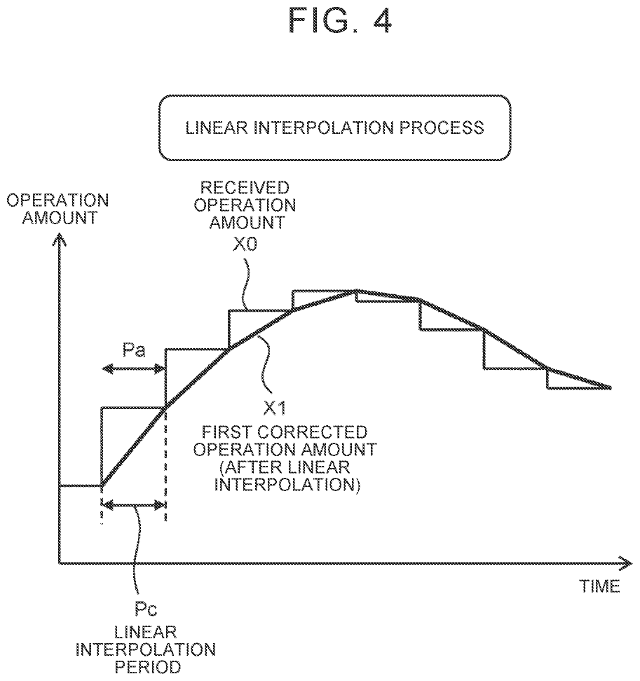

For example, the smoothing portion 120 includes a linear interpolation portion 121 configured to perform a “linear interpolation process.” FIG. 4 is a conception diagram to describe the linear interpolation process. The linear interpolation process is a process of linearly interpolating the received operation amount X0 between two consecutive timings. A linear interpolation period Pc is a period between the two consecutive timings. For simplification, FIG. 4 illustrates a case where the communication period Pa (reception period) is uniform, and the linear interpolation period Pc is equal to the communication period Pa. An operation amount to be obtained as a result of the linear interpolation process performed on the received operation amount X0 is hereinafter referred to as a “first corrected operation amount X1.” The first corrected operation amount X1 changes more smoothly than the received operation amount X0. The linear interpolation portion 121 applies linear interpolation to the received operation amount X0 to calculate the first corrected operation amount X1 that changes more smoothly.

Note that it is also conceivable that a future operation amount X is predicted by extrapolating the received operation amount X0. However, in actual remote assistance, the communication period Pa changes non-uniformly, and therefore, it is difficult to predict the communication period Pa. Accordingly, the predictability of the operation amount X by extrapolation is low. Particularly, in the case of extrapolation, a predicted value for the operation amount X decreases or increases monotonically, so that the predicted value might be a value deviating from the intention of the remote operator O. From this viewpoint, the linear interpolation process using one previous sampling value is desirable.

In the example illustrated in FIG. 3, the smoothing portion 120 further includes an LPF portion 122 configured to perform a “filtering process.” The LPF portion 122 calculates a second corrected operation amount X2 by applying lowpass filtering to the first corrected operation amount X1. The second corrected operation amount X2 changes more smoothly than the first corrected operation amount X1. In the example illustrated in FIG. 3, the second corrected operation amount X2 is output from the smoothing portion 120 as the corrected operation amount XC.

Note that the smoothing portion 120 does not necessarily need to include both of the linear interpolation portion 121 and the LPF portion 122. The smoothing portion 120 may include either one of the linear interpolation portion 121 and the LPF portion 122. In a case where the smoothing portion 120 includes only the linear interpolation portion 121, the first corrected operation amount X1 is output from the smoothing portion 120 as the corrected operation amount XC. In a case where the smoothing portion 120 includes only the LPF portion 122, the LPF portion 122 calculates the second corrected operation amount X2 by applying lowpass filtering to the received operation amount X0. Then, the second corrected operation amount X2 is output from the smoothing portion 120 as the corrected operation amount XC.

When this is generalized, the smoothing portion 120 calculates the corrected operation amount XC by applying at least either one of the linear interpolation and the lowpass filtering to the received operation amount X0. The corrected operation amount XC obtained as such changes more smoothly than the received operation amount X0.

The controlling portion 150 performs the vehicle traveling control based on the corrected operation amount XC that changes more smoothly than the received operation amount X0. This accordingly restrains vibrations or abnormal noise of the actuator.

FIGS. 5A to 5C are conception diagrams to describe effects of the smoothing process. As an example, the following discusses a case where the operation amount X is a target angle for steering.

FIG. 5A illustrates a case where the smoothing process is not performed. Since the target angle changes in a stepped manner, the target angular velocity suddenly changes, so that the output torque from the turning motor configured to turn the wheels also suddenly changes. As a result, vibrations or abnormal noise of the turning motor occurs.

FIG. 5B illustrates a case where the linear interpolation process is performed. Since the target angle changes more smoothly, sudden changes in the target angular velocity are restrained. As a result, fluctuations in the output torque are also restrained, thereby resulting in that vibrations or abnormal noise of the turning motor is restrained. However, since the target angular velocity suddenly changes to some extent at inflection points of the target angle, microvibrations or abnormal noise might remain.

FIG. 5C illustrates a case where the linear interpolation process and the filtering process are performed. Since the target angle changes further more smoothly, sudden changes in the target angular velocity are further effectively restrained. As a result, fluctuations in the output torque are also further effectively restrained, thereby resulting in that vibrations or abnormal noise of the turning motor is further effectively restrained.

3. Smoothing Process in Consideration of Changes in Communication Period

The communication period Pa for the operation amount X changes non-uniformly in practice. For example, the communication period Pa changes in accordance with the communication state between the vehicle 100 and the remote operator terminal 200. When congestion occurs in the communication network, for example, the communication period Pa becomes longer. As another example, the remote operator terminal 200 may dynamically set the communication period Pa so as to optimize a communication load.

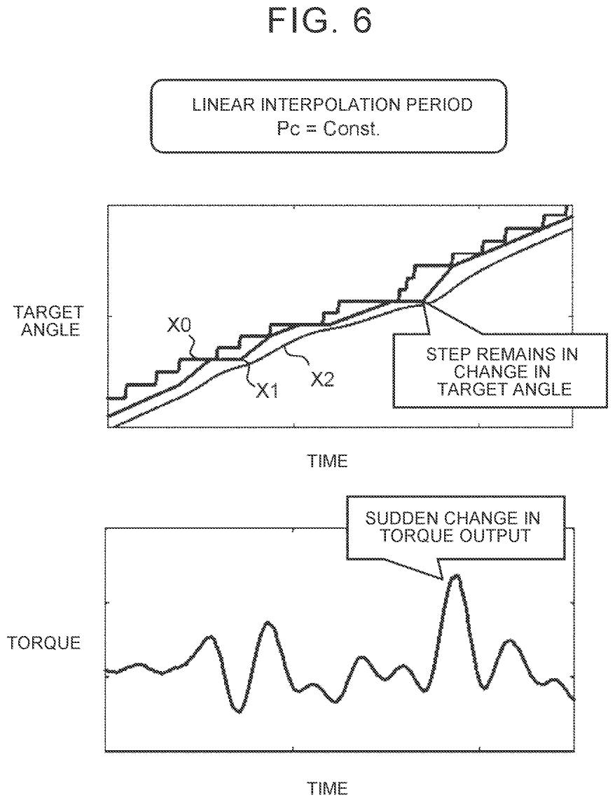

In a case where the linear interpolation period Pc is uniform in a state where the communication period Pa changes, the following problem occurs. FIG. 6 is a conception diagram to describe the problem. In a case where the communication period Pa increases to become longer than the linear interpolation period Pc (Pa>Pc), the received operation amount X0 that changes in a stepped manner might not be smoothed sufficiently. In other words, a “step” might remain in the change in the first corrected operation amount X1 to be obtained by linear interpolation. In that case, due to a fluctuation in the output torque, vibrations or abnormal noise of the actuator might remain to some extent. That is, the effect of the linear interpolation process weakens. The following describes a smoothing process that can solve this problem.

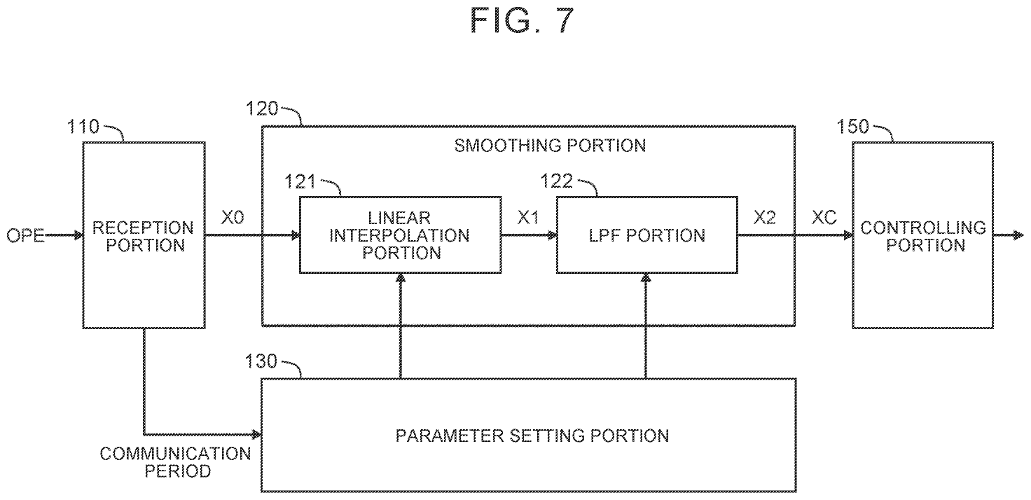

FIG. 7 is a block diagram illustrating an exemplary functional configuration related to the smoothing process according to the present embodiment. The vehicle 100 further includes a parameter setting portion 130 in addition to the functional block illustrated in FIG. 3. Descriptions that have been described in FIG. 3 are omitted appropriately.

The parameter setting portion 130 dynamically sets a parameter related to the smoothing process in accordance with a situation. The parameter related to the smoothing process is at least either of the linear interpolation period Pc and a cut-off frequency in lowpass filtering. More particularly, the parameter setting portion 130 dynamically sets a parameter related to the smoothing process in accordance with the communication period Pa that changes. Accordingly, the reception portion 110 grasps the communication period Pa (reception period) for the operation amount X in real time based on a reception result of the remote operation information OPE (the received operation amount X0). The reception portion 110 provides information on the communication period Pa for the operation amount X to the parameter setting portion 130 in real time.

The dynamic setting of the linear interpolation period Pc is performed as follows. As the communication period Pa for the operation amount X is longer, the parameter setting portion 130 sets the linear interpolation period Pc to be longer. That is, the parameter setting portion 130 increases the linear interpolation period Pc in conjunction with an increase in the communication period Pa of the operation amount X. As a result, the communication period Pa is hard to become longer than the linear interpolation period Pc, thereby making it possible to achieve the effect of the linear interpolation process as intended.

For example, the parameter setting portion 130 sets the linear interpolation period Pc to be equal to or more than the communication period Pa (Pc≥Pa). This prevents the communication period Pa from becoming longer than the linear interpolation period Pc, thereby making it possible to achieve the effect of the linear interpolation process as intended.

For example, the parameter setting portion 130 accumulates histories of the communication period Pa. The parameter setting portion 130 calculates an average value μ and a standard deviation a of the communication period Pa in a given period of time. Then, the parameter setting portion 130 sets a value obtained by adding a predetermined value to the average value μ of the communication period Pa as the linear interpolation period Pc. For example, the parameter setting portion 130 sets “μ+3σ” as the linear interpolation period Pc. Hereby, the linear interpolation period Pc becomes longer than the communication period Pa.

As another example, in a case where the remote operator terminal 200 dynamically sets the communication period Pa to optimize a communication load, the remote operator terminal 200 may notify the vehicle 100 of a set value for the communication period Pa. The reception portion 110 outputs, to the parameter setting portion 130, the set value for the communication period Pa that is notified of from the remote operator terminal 200. The parameter setting portion 130 sets the linear interpolation period Pc by adding a predetermined value a to the set value for the communication period Pa. Hereby, the linear interpolation period Pc becomes longer than the communication period Pa.

As further another example, the parameter setting portion 130 may set the linear interpolation period Pc to be equal to the communication period Pa (Pc=Pa). In this case, a phase delay of the corrected operation amount XC due to the linear interpolation process is restrained. That is, the delay of the remote operation on the vehicle 100 is restrained. As a result, it is possible to restrain the remote operation on the vehicle 100 by the remote operator O from becoming awkward.

The cut-off frequency in the lowpass filtering is dynamically set as follows. As the communication period Pa for the operation amount X is longer, the parameter setting portion 130 sets the cut-off frequency in the lowpass filtering to be lower. That is, the parameter setting portion 130 decreases the cut-off frequency in the lowpass filtering in conjunction with an increase in the communication period Pa for the operation amount X. As a result, even when the communication period Pa becomes long, the corrected operation amount XC easily changes smoothly, and thus, the above problem is solved.

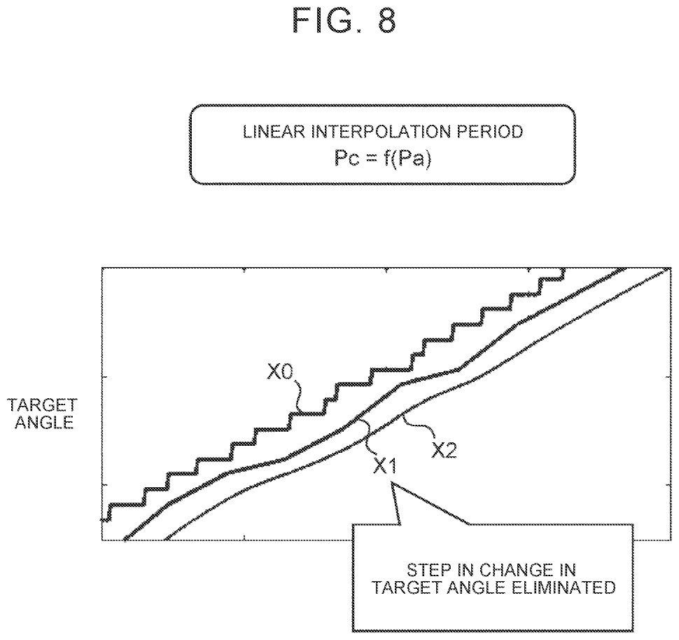

FIG. 8 is a conception diagram to describe an effect to be obtained by the dynamic setting of the parameters related to the smoothing process. The “steps” in the change in the first corrected operation amount X1 to be obtained by the linear interpolation process are eliminated, and further, the second corrected operation amount X2 to be obtained by the filtering process changes more smoothly. This sufficiently restrains fluctuations in the output torque, thereby making it possible to sufficiently restrain vibrations or abnormal noise of the actuator.

Note that the parameter to be set dynamically may be at least either of the linear interpolation period Pc and the cut-off frequency in the lowpass filtering. In a case where the smoothing portion 120 includes both of the linear interpolation portion 121 and the LPF portion 122, at least either of the linear interpolation period Pc and the cut-off frequency in the lowpass filtering is set dynamically in accordance with the communication period Pa. Even in a case where at least either of the linear interpolation period Pc and the cut-off frequency in the lowpass filter is set dynamically in accordance with the communication period Pa, at least the effect is obtained. In a case where the smoothing portion 120 includes only the linear interpolation portion 121, the linear interpolation period Pc is set dynamically in accordance with the communication period Pa. In a case where the smoothing portion 120 includes only the LPF portion 122, the cut-off frequency in the lowpass filtering is set dynamically in accordance with the communication period Pa.

When the above description is generalized, the smoothing portion 120 calculates the corrected operation amount XC by applying at least either one of the linear interpolation and the lowpass filtering to the received operation amount X0. As the communication period Pa is longer, the parameter setting portion 130 sets the linear interpolation period Pc to be longer and decreases the cut-off frequency in the lowpass filtering, or alternatively, the parameter setting portion 130 sets the linear interpolation period Pc to be longer or decreases the cut-off frequency in the lowpass filtering. This further effectively restrains the occurrence of vibrations or abnormal noise in the vehicle traveling control.

4. Vehicle-Speed Restriction Process

As described above, as the communication period Pa is longer, the parameter setting portion 130 sets the linear interpolation period Pc to be longer and decreases the cut-off frequency in the lowpass filtering, or alternatively, the parameter setting portion 130 sets the linear interpolation period Pc to be longer or decreases the cut-off frequency in the lowpass filtering. A phase delay in the corrected operation amount XC increases due to the increase in the linear interpolation period Pc and the decrease in the cut-off frequency in the lowpass filtering or due to the increase in the linear interpolation period Pc or the decrease in the cut-off frequency in the lowpass filtering. The vehicle 100 is controlled based on the corrected operation amount XC, and therefore, when the phase delay in the corrected operation amount XC increases, the remote operation on the vehicle 100 by the remote operator O may become awkward. In some cases, the vehicle 100 moves in a zigzag manner. This is unfavorable from the viewpoint of stability in the behavior of the vehicle 100 during the remote operation.

In view of this, in a situation where the phase delay in the corrected operation amount XC increases along with an increase in the communication period Pa, the vehicle speed of the vehicle 100 may be restricted in order to secure stability in the vehicle behavior. Such a process is hereinafter referred to as a “vehicle-speed restriction process.”

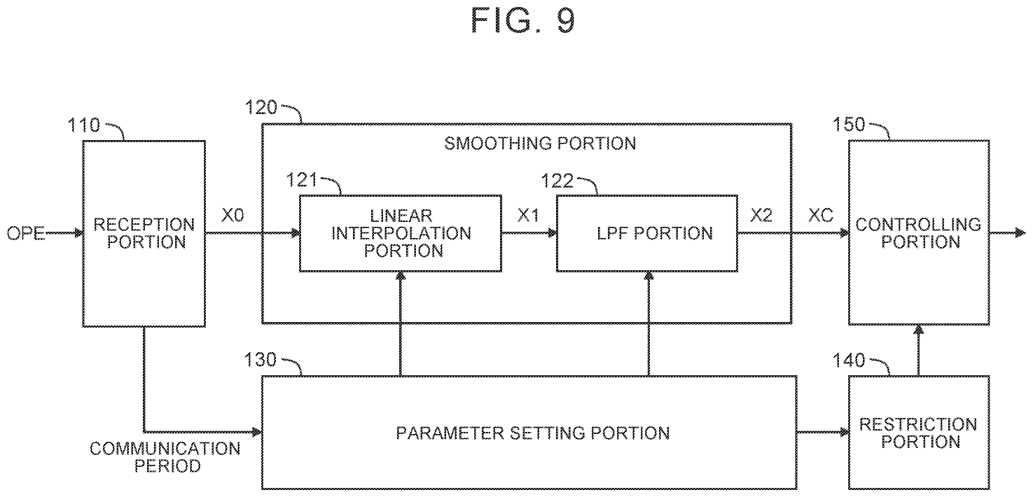

FIG. 9 is a block diagram illustrating an exemplary functional configuration related to the smoothing process and the vehicle-speed restriction process according to the present embodiment. The vehicle 100 further includes a restriction portion 140 configured to perform the vehicle-speed restriction process in addition to the functional block illustrated in FIG. 7. Descriptions that have been described in FIG. 7 are omitted appropriately.

The restriction portion 140 restricts the vehicle speed of the vehicle 100 in accordance with an increase in the phase delay in the corrected operation amount XC. That is, as the phase delay in the corrected operation amount XC increases, the restriction portion 140 decreases the upper limit of the vehicle speed. In other words, as the linear interpolation period Pc increases, or as the cut-off frequency in the lowpass filtering decreases, the restriction portion 140 decreases the upper limit of the vehicle speed. Further in other words, as the communication period Pa becomes longer, the restriction portion 140 decreases the upper limit of the vehicle speed. The controlling portion 150 controls the vehicle 100 such that the vehicle speed is equal to or less than the upper limit set by the restriction portion 140.

Due to such a vehicle-speed restriction process, the stability in the vehicle behavior is secured even in a situation where the phase delay in the corrected operation amount XC increases along with an increase in the communication period Pa.

5. Example of Vehicle

5-1. Exemplary Configuration

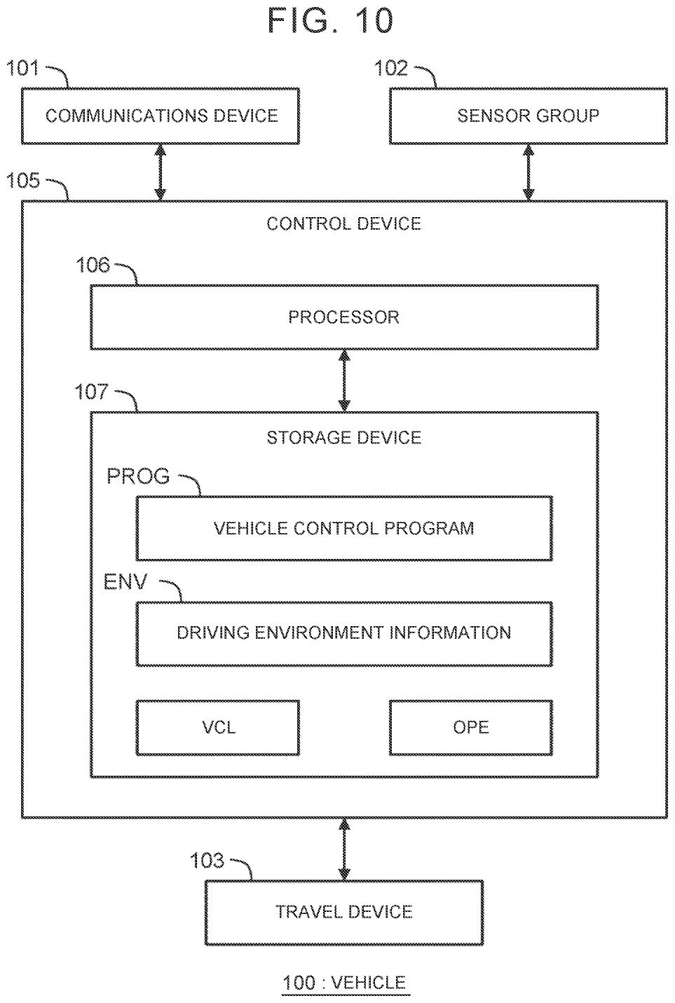

FIG. 10 is a block diagram illustrating an exemplary configuration of the vehicle 100. The vehicle 100 includes a communications device 101, a sensor group 102, a travel device 103, and a control device 105.

The communications device 101 communicates with an external device outside the vehicle 100. For example, the communications device 101 communicates with the remote operator terminal 200 or the management apparatus 300.

The sensor group 102 includes a recognition sensor, a vehicle state sensor, a position sensor, and so on. The recognition sensor recognizes (detects) a state around the vehicle 100. Examples of the recognition sensor include a camera, a laser imaging detection and ranging (LIDAR) system, a radar, and so on. The vehicle state sensor detects the state of the vehicle 100. The vehicle state sensor includes a speed sensor, an acceleration sensor, a yaw rate sensor, a steering angle sensor, and so on. The position sensor detects the position and the direction of the vehicle 100. The position sensor includes a global navigation satellite system (GNSS), for example.

The travel device 103 is an actuator configured to move the vehicle 100. The travel device 103 includes a steering device, a driving device, and a braking device. The steering device turns the wheels. For example, the steering device includes a power steering (electric power steering (EPS)) device. The driving device is a power source configured to generate driving force. Examples of the driving device include an engine, an electric machine, an in-wheel type motor, and so on. The braking device generates braking force.

The control device 105 is a computer configured to control the vehicle 100. The control device 105 includes one or more processors 106 (hereinafter just referred to as the processor 106) and one or more storage devices 107 (hereinafter just referred to as the storage device 107). The processor 106 executes various processes. For example, the processor 106 includes a central processing unit (CPU). Various pieces of information necessary for a process to be executed by the processor 106 are stored in the storage device 107. Examples of the storage device 107 include a volatile memory, a nonvolatile memory, a hard disk drive (HDD), a solid state drive (SSD), and so on. The control device 105 may include one or more electronic control units (ECU).

A vehicle control program PROG is a computer program to be executed by the processor 106. When the processor 106 executes the vehicle control program PROG, the function of the control device 105 is implemented. The vehicle control program PROG is stored in the storage device 107. Alternatively, the vehicle control program PROG may be stored in a computer-readable recording medium (storage medium).

5-2. Driving Environment Information

The control device 105 acquires driving environment information ENV indicative of a driving environment of the vehicle 100 by use of the sensor group 102. The driving environment information ENV is stored in the storage device 107.

The driving environment information ENV includes surrounding state information indicative of a recognition result from the recognition sensor. For example, the surrounding state information includes image information on an image captured by a camera. The surrounding state information may include object information on an object around the vehicle 100. Examples of the object around the vehicle 100 include pedestrians, other vehicles (a leading vehicle, a parked vehicle, and so on), white lines, traffic lights, marks, roadside structural objects, and so on. Object information indicates a relative position and a relative speed of the object relative to the vehicle 100.

Further, the driving environment information ENV includes vehicle state information indicative of a vehicle state detected by the vehicle state sensor.

Further, the driving environment information ENV includes vehicle position information indicative of the position and the direction of the vehicle 100. The vehicle position information is obtained by a position sensor. The control device 105 may acquire highly accurate vehicle position information by a self-position estimation process (Localization) using map information and the surrounding state information (the object information).

5-3. Vehicle Traveling Control

The control device 105 executes the vehicle traveling control by which the traveling of the vehicle 100 is controlled. The vehicle traveling control includes a steering control, a driving control, and a braking control. The control device 105 executes the vehicle traveling control by controlling the travel device 103 (the steering device, the driving device, and the braking device) as the actuator.

The control device 105 may perform a self-driving control based on the driving environment information ENV. More particularly, the control device 105 generates a traveling plan of the vehicle 100 based on the driving environment information ENV. Further, the control device 105 generates a target trajectory necessary for the vehicle 100 to travel along the traveling plan based on the driving environment information ENV. The target trajectory includes a target position and a target speed. Then, the control device 105 performs the vehicle traveling control such that the vehicle 100 follows the target trajectory.

5-4. Process Related to Remote Operation

The following describes a case where the remote operation on the vehicle 100 is performed. The control device 105 communicates with the remote operator terminal 200 via the communications device 101.

The control device 105 transmits the vehicle information VCL to the remote operator terminal 200. The vehicle information VCL is information necessary for the remote operation performed by the remote operator O and includes at least part of the abovementioned driving environment information ENV. For example, the vehicle information VCL includes the surrounding state information (image information, in particular). The vehicle information VCL may further include the vehicle state information or the vehicle position information.

Further, the control device 105 receives the remote operation information OPE from the remote operator terminal 200. The remote operation information OPE is information on the remote operation performed by the remote operator O. The remote operation information OPE includes the operation amount X by the remote operator O. The control device 105 performs the vehicle traveling control based on the operation amount X indicated by the remote operation information OPE.

More particularly, the control device 105 includes, as functional blocks, the reception portion 110, the smoothing portion 120, the parameter setting portion 130, the restriction portion 140, and the controlling portion 150 described above. These functional blocks are implemented when the processor 106 executes the vehicle control program PROG. When the control device 105 performs the smoothing process in the middle of the remote operation, vibrations or abnormal noise of the travel device 103 (the actuator) is restrained. Further, the stability in the vehicle behavior is secured when the control device 105 performs the vehicle-speed restriction process as needed.

What is claimed is:

1. A control method for controlling a movable body by a remote operation performed by a remote operator, the control method comprising:
receiving information including an operation amount by the remote operator via communication;
calculating a corrected operation amount by applying at least either one of linear interpolation and lowpass filtering to the received operation amount;
controlling the movable body based on the corrected operation amount; and
setting a period for the linear interpolation to be longer and decreasing a cut-off frequency in the lowpass filtering as a communication period for the operation amount is longer, or setting the period for the linear interpolation to be longer or decreasing the cut-off frequency in the lowpass filtering as the communication period for the operation amount is longer.

2. The control method according to claim 1, wherein:
the calculating of the corrected operation amount includes applying the linear interpolation to the received operation amount; and
as the communication period for the operation amount is longer, the period for the linear interpolation is longer.

3. The control method according to claim 2, wherein the period for the linear interpolation is set to be equal to or more than the communication period for the operation amount.

4. The control method according to claim 3, wherein the period for the linear interpolation is set to a value obtained by adding a predetermined value to the communication period for the operation amount.

5. The control method according to claim 3, wherein the period for the linear interpolation is set to be equal to the communication period for the operation amount.

6. The control method according to claim 1, wherein the calculating of the corrected operation amount includes:
calculating a first corrected operation amount by applying the linear interpolation to the received operation amount; and
calculating the corrected operation amount by applying the lowpass filtering to the first corrected operation amount.

7. The control method according to claim 1, further comprising restricting a speed of the movable body in accordance with an increase in a phase delay in the corrected operation amount due to an increase in the period for the linear interpolation and a decrease in the cut-off frequency in the lowpass filtering or in accordance with an increase in a phase delay in the corrected operation amount due to an increase in the period for the linear interpolation or a decrease in the cut-off frequency in the lowpass filtering.

8. A control device for controlling a movable body by a remote operation performed by a remote operator, the control device comprising one or more processors wherein the one or more processors is configured to:
receive information including an operation amount by the remote operator via communication;
calculate a corrected operation amount by applying at least either one of linear interpolation and lowpass filtering to the received operation amount;
control the movable body based on the corrected operation amount; and
set a period for the linear interpolation to be longer and decrease a cut-off frequency in the lowpass filtering as a communication period for the operation amount is longer, or set the period for the linear interpolation to be longer or decrease the cut-off frequency in the lowpass filtering as the communication period for the operation amount is longer.

9. The control device according to claim 8, wherein the one or more processors is configured to further restrict a speed of the movable body in accordance with an increase in a phase delay in the corrected operation amount due to an increase in the period for the linear interpolation and a decrease in the cut-off frequency in the lowpass filtering or in accordance with an increase in a phase delay in the corrected operation amount due to an increase in the period for the linear interpolation or a decrease in the cut-off frequency in the lowpass filtering.

10. A non-transitory storage medium storing a control program for controlling a movable body by a remote operation performed by a remote operator, the control program being executed by a computer, the control program causing the computer to:
receive information including an operation amount by the remote operator via communication;
calculate a corrected operation amount by applying at least either one of linear interpolation and lowpass filtering to the received operation amount;
control the movable body based on the corrected operation amount; and
set a period for the linear interpolation to be longer and decrease a cut-off frequency in the lowpass filtering as a communication period for the operation amount is longer, or set the period for the linear interpolation to be longer or decrease the cut-off frequency in the lowpass filtering as the communication period for the operation amount is longer.
